(19) United States
(12) Patent Application Publication
(10) Pub. No.: US 2007/0246662 A1
(43) Pub. Date: Oct. 25, 2007

(54) Radiation image phosphor or scintillator panel

(76) Inventors: Jean-Pierre Tahon, Langdorp (BE); Paul Leblans, Kontich (BE); Carlo Uyttendaele, Mortsel (BE); Alexander Williamson, Mortsel (BE)

Correspondence Address: NEXSEN PRUET, LLC, P.O. BOX 10648, GREENVILLE, SC, 29603, US

(21) Appl. No.: 11/716,950

(22) Filed: Mar. 12, 2007

Related U.S. Application Data
(60) Provisional application No. 60/794,427, filed on Apr. 24, 2006.

(30) Foreign Application Priority Data
Apr. 20, 2006 (EP) 06112799

(51) Int. Cl. H05B 33/00

(52) U.S. Cl. 250/484.4

(57) ABSTRACT

In favor of adhesion a radiation image phosphor or scintillator panel comprises as an arrangement of layers, in consecutive order, an anodized aluminum support, a precoat layer and a phosphor or scintillator layer comprising needle-shaped phosphor or scintillator crystals, wherein said precoat layer has a thickness in the range from 4 μm to 15 μm when consisting of an organic polymer selected from the group consisting of cellyte, poly-acrylate, poly-methyl-methacrylate, poly-methylacrylate, polystyrene, polystyrene-acrylonitrile, polyurethane, hexafunctional polyacrylate, poly-vinylidene-difluoride, epoxy functionalized polymers or wherein said precoat layer has a thickness in the range from 1 μm to less than 5 μm when consisting of an organo-silane based polymer.

### CROSS-REFERENCE TO RELATED PATENT APPLICATIONS

This application claims the benefit of U.S. Provisional Application No. 60/794,427 filed Apr. 24, 2006, which is incorporated by reference. In addition, this application claims the benefit of European Application No. 06112799.9 filed Apr. 20, 2006, which is also incorporated by reference.

### FIELD OF THE INVENTION

The present invention is related with a binderless radiation image phosphor or scintillator panel provided with a vapor deposited phosphor or scintillator layer upon an aluminum support, modified in order to provide an excellent adhesiveness.

### BACKGROUND OF THE INVENTION

Radiation image recording systems wherein a radiation image is recorded on a phosphor or scintillator screen by exposing the screen to image-wise modulated penetrating radiation are widely used nowadays.

In the case of storage phosphor screens a recorded image is reproduced by stimulating an exposed photostimulable phosphor screen by means of stimulating radiation and by detecting the light that is emitted by the phosphor screen upon stimulation and converting the detected light into an electrical signal representation of the radiation image.

In several applications as e.g. in mammography, sharpness of the image is a very critical parameter. Sharpness of an image that has been read out of a photostimulable phosphor screen not only depends on the sharpness and resolution of the screen itself but also on the resolution obtained by the read-out system which is used.

In conventional read out systems used nowadays a scanning unit of the flying spot type is commonly used. Such a scanning unit comprises a source of stimulating radiation, e.g. a laser light source, means for deflecting light emitted by the laser so as to form a scanning line on the photostimulable phosphor screen and optical means for focusing the laser beam onto the screen.

Examples of such systems are the Agfa Diagnostic Systems, denominated by the trade name ADC 70 and Agfa Compact. In these systems photostimulable phosphor screens which comprise a BaFBr:Eu phosphor are commonly used.

The resolution of the read-out apparatus is mainly determined by the spot size of the laser beam. This spot size in its turn depends on the characteristics of the optical light focusing arrangement. It has been recognized that optimizing the resolution of a scanning system may result in loss of optical collection efficiency of the focusing optics. As a consequence an important fraction of the laser light is not focused onto the image screen. A severe prejudice exists against the use of systems having an optical collection efficiency of the focusing optics which is less than 50% because these systems were expected not to deliver an adequate amount of power to the screen in order to read out this screen to a sufficient extent within an acceptable scanning time. A solution has therefor been sought and found as disclosed in U.S. Pat. No. 6,501,088. Therein use has been made of a method for reading a radiation image that has been stored in a photostimulable phosphor screen comprising the steps of scanning said screen by means of stimulating radiation emitted by a laser source, detecting light emitted by said screen upon stimulation, converting detected light into an electrical signal representation of said radiation image, wherein said photostimulable phosphor screen comprises a divalent europium activated cesium halide phosphor wherein said halide is at least one of chloride and bromide and said laser beam is focused so that the spot diameter of the laser spot emitted by said laser, measured between 1/e² points of the gaussian profile of said laser beam is smaller than 100 μm. Object of that invention to provide a method and a system for reading a radiation image that has been stored in a photostimulable phosphor screen was resulting, besides in a method and a system for reading a radiation image stored in a photostimu-lable phosphor screen having a needle-shaped storage phosphor layer, in a method and system yielding a high sharpness.

In US-A 2004/0149929 a radiation image storage panel has been disclosed, composed of a support, a phosphor matrix compound layer covering a surface of the support at a coverage percentage of 95% or more, and a stimulable phosphor layer (which is composed of multiple prismatic stimulable phosphor crystals standing on the phosphor matrix compound layer) formed on the phosphor matrix compound layer, thereby providing a high peel resistance between the support and the stimulable phosphor layer, a high sensitivity, and a reproduced radiation image of high quality.

However, in a radiation image transformation panel, in order to attain the desired radiation absorbing power the needle shaped europium doped cesium halide storage phosphor must be formed in a layer having a thickness of about 200-800 μm. Since the parent compound of the photostimulable phosphor consisting of alkali halide compound, such as CsBr, has a large thermal expansion coefficient of about 50×10⁻⁶/° K, cracks may appear in such a relatively thick layer so that adhesion of the storage phosphor layer onto the support substrate may become a problem, leading to delamination. Factors having a negative influence onto cracking and delamination are related, besides with substrate temperature and changes thereof during the vapor deposition process, with the pressure of inert gas in the vacuum chamber and with presence of impurities, which have a significant influence upon crystallinity of the deposited phosphor layer during said vapor deposition process. In order to solve that problem, a solution has been proposed in JP-A 2005-156411. In that application a first vapor deposited layer was formed onto the substrate, wherein said layer was containing an alkali halide compound with a molecular weight smaller than the parent compound of the photostimulable phosphor. The layer with the vapor deposited stimulable europium doped cesium halide phosphor was further deposited thereupon. Nevertheless as a first layer between substrate and storage phosphor layer is a vapor deposited layer again, same problems were met with respect to cracks and delamination and the expected improvement with respect thereto was not yet fully obtained.

In U.S. Pat. No. 6,870,167 a process for the preparation of a radiation image storage panel having a phosphor layer which comprises a phosphor comprising a matrix component and an activator component, which comprises the steps of: forming on a substrate a lower prismatic crystalline layer comprising the matrix component by vapor deposition, and forming on the lower prismatic crystalline layer an upper prismatic crystalline layer comprising the matrix component and the activator component by vapor deposition as an arrangement favorable for crystallinity of said upper layer. In favor of adhesion however it has been proposed in US-Application 2005/51736 to make use of spherical shaped phosphors in the lower layer.

When performing vapor deposition techniques in order to prepare phosphor layers onto dedicate substrates, a highly desired substrate material whereupon the scintillator or phosphor material should be deposited is made of glass, a ceramic material, a polymeric material or a metal. As a metal base-material use is generally made of metal sheets of aluminum, steel, brass, titanium and copper. Particularly preferred as a substrate is aluminum as a very good heat-conducting material allowing a perfect homogeneous temperature, not only over the whole substrate surface but also in the thickness direction: such heat conductivities are in the range from 0.05-0.5 W/(m·K).

Since completely pure aluminum is not easily produced from a point of view of a refining technology, aluminum supports containing other elements in the aluminum alloy like silicon, iron, manganese, copper, magnesium, chromium, zinc, bismuth, nickel and titanium have been used as described in U.S. Pat. Nos. 3,787,249 and 3,720,508, wherein, as in automotive applications, bright anodized aluminum alloys having appearance somewhat similar to buffed stainless steels or to chrome-plated brass are much more economical to the user. Said alloys have markedly improved resistance to oxidation in the temperature range of 440° to 500° C. which results in improved surface appearance after hot rolling and are tolerant to a broader range of solution composition in which they can be bright dipped. Alloys described in U.S. Pat. No. 4,235,682 further exhibit substantially improved brightness after anodizing in sulphuric acid and sealing.

It should be noted however that in order to perform vapor deposition of two vapor deposited layers as has e.g. been described in U.S. Pat. Nos. 6,870,167 and 6,967,339, or in US-Application 2005/0077479 two different processes in a vapor depositing apparatus are required in order to deposit different raw starting materials in each layer: as it is known that increased dopant amounts in the upper layer lead to a desired higher sensitivity of the storage phosphor screen thus formed, it can be expected that higher dopant amounts lead to enhanced cracking and decreased adhesion of the coated layers. Otherwise in order to have better reflection properties in favor of reflection of light emitted upon stimulation of the storage phosphors and, as a consequence thereof, an enhanced sensitivity, it can be expected that a more mirror-like smoother support surface is not in favor of a better adhesion of phosphor layers, deposited thereupon.

Besides a good compromise between physical characteristics as roughness of the support and cracking of the phosphor or scintillator layers, as well as between speed and sharpness properties, it is clear that another physical characteristic as a good adhesion between aluminum support and phosphor or scintillator layer remains an ever lasting demand.

### SUMMARY OF THE INVENTION

It is a main object of the present invention to have excellent adhesion characteristics between vapor deposited phosphor or scintillator layers having a thickness of 100 μm up to 1000 μm and support layers, and, more in particular, aluminum supports.

The above-mentioned advantageous effects have been realized by providing a storage phosphor panel having the specific features set out in claim 1. Specific features for preferred embodiments of the invention are set out in the dependent claims.

It has been found now that, in order to get good adhesion characteristics for vapor deposited phosphor or scintillator panels deposited onto an aluminum support in the preparation of a radiation image screen or panel, said image phosphor or scintillator panels advantageously have a layer arrangement of consecutive layers being an anodized aluminum support, a precoat layer and a phosphor or scintillator layer comprising needle-shaped phosphor or scintillator crystals, wherein said precoat layer is consisting of an organic polymer and wherein said precoat layer has a thickness of less than 20 μm, i.e., that in a first particular embodiment thereof said precoat layer has a thickness in the range from 4 μm to 15 μm when consisting of an organic polymer selected from the group consisting of cellyte, poly-acrylate, poly-methyl-methacrylate, poly-methylacrylate, polystyrene, polystyrene-acrylonitrile, polyurethane, hexafunctional polyacrylate, poly-vinylidene-difluoride and epoxy functionalized polymers and that in a second particular embodiment said precoat layer has a thickness in the range from 1 μm to less than 5 μm, when consisting of an organo-silane based polymer, as a thin precoat layer upon a very thin anodized aluminum layer, showing thereby good adhesion of the phosphor layer and resistance to detrimental loss of speed as a consequence of conditioning of the phosphor plate in severe circumstances of humidity and temperature.

More particular embodiments of the phosphor or scintillator panels according to the present invention are as follows:

in one embodiment a sublayer comprising an inorganic compound is present between said anodized aluminum support and said organic precoat layer;

said inorganic compound is a metal compound or an oxide compound, wherein said metal is selected from the group consisting of tin, copper, nickel, chromium, scandium, yttrium, tantalum, vanadium, titanium, niobium, cobalt, zirconium, molybdene and tungsten;

in another embodiment a sublayer comprising an organic compound is present between said anodized aluminum support and said organic precoat layer;

in one embodiment thereof in said sublayer said organic compound is a polymer, selected from the group consisting of cellyte, polyacrylate, poly-methyl-methacrylate, poly-methylacrylate, polystyrene, polystyrene-acrylonitrile, polyurethane, hexafunctional polyacrylate, poly-vinylidene-difluoride and epoxy functionalized polymers;

in another embodiment thereof in said sublayer said organic compound is poly-p-xylylene;

said precoat layer and/or said sublayer further contains one or more chromium compound(s);

said stimulable phosphor or scintillator layer comprises needle-shaped phosphor or scintillator crystals having an alkali metal halide as a matrix compound and a lanthanide as an activator compound;

said needle-shaped phosphor is a photostimulable CsBr:Eu phosphor.

In a method of preparing a radiation image phosphor or scintillator panel having the features as described above, said phosphor or scintillator layer is coated by a technique selected from the group consisting of physical vapor deposition, chemical vapor deposition and an atomization technique.

In a further embodiment of the preparation method said precoat layer is coated by a technique selected from the group consisting of roller coating, knife coating, doctor blade coating, spray coating, sputtering, physical vapor deposition and chemical vapor deposition.

Further advantages and particular embodiments of the present invention will become apparent from the following description, without however limiting the invention thereto.

### DETAILED DESCRIPTION OF THE INVENTION

According to the present invention said precoat layer thickness in the layer arrangement of a radiation image storage phosphor or scintillator panel is less than 20 μm, and even preferably less than 15 μm, i.e. in the range from 4 μm to 15 μm or in the range from 1 μm to less than 5 μm, depending on the type of polymer coated as polymer precoat layer as has further been explained hereinafter.

In one embodiment precoat layers having a thickness in the range from 4 μm to 15 μm in radiation image panels according to the present invention are consisting of polymers selected from the group consisting of cellyte, poly-acrylate, poly-methyl-methacrylate, poly-methyl-acrylate, polystyrene, polystyrene-acrylonitrile, polyurethane, hexafunctional acrylates, as e.g. “Ebecryl” from UCB, Belgium, polyacrylate, poly-vinylidene-difluoride (PVDF) and epoxy functionalized polymers, as epoxy resins.

In another embodiment precoat layers having a thickness in the range from 1 μm to less than 5 μm in radiation image panels according to the present invention are consisting of an organo-silane based polymer. In a preferred embodiment thereof, said organo-silane based polymer is organo-tetrasilane.

Furtheron polymers selected from the group consisting of silazane and siloxazane type polymers, mixtures thereof and mixtures of said silazane or siloxazane type polymers with compatible film-forming polymers may be applied in form of a solution, thus forming polymeric films thereof having a thickness after drying as set forth hereinbefore. In another embodiment barrier layers may be coated consisting of a organic-anorganic composite material, wherein the said composite material consists of a polymer containing a monomer functionalized with an alkoxy silane group which is further crosslinked by controlled hydrolysis and condensation with at least one metal alkoxide, most preferably an tetraalkoxysilane such as tetraethoxysilane. Sol-gel reactions, well-known in scientific literature, describe in its original form a chemical route to synthetize inorganic polymers like glass or ceramics via a colloidal phase in solution. The basic chemistry that may be applied therefor is known since about 150 years (see Ebelmen, “Untersuchungen uber die Verbindungen der Borsaüre und Kieselsaüre mit Ether”, Ann. 57 (1846), p. 319-355). The general sol-gel reaction scheme is composed of a series of hydrolysis steps in conjunction with condensation steps. During the growth reaction a colloid phase with particles or macromolecules in the nm range appear (sol) finally leading to a solid with a second phase within its pores. More recently the sol-gel reaction has been used to prepare inorganic-organic hybrid materials. In this general reaction hydrolysis and condensation of a metal alkoxide species such as TEOS take place, and a network is formed in the process. During the build-up of this anorganic network appropriately functionalized organic moieties that can also undergo the same condensation reaction as the hydrolyzed metal alkoxides are also incorporated in the network. Particular types of inorganic-organic hybrid materials are named ORMOCERS, ORMOSILS or CERAMERS. Scientific literature on inorganic-organic hybrid materials include: “The synthesis, structure and property behavior of inorganic-organic hybrid network materials prepared by the sol-gel process”, Wilkes at al., Proceedings of MRS Meeting, Boston Mass., November 1989; “Sol-gel processes II: investigation and application”, H. Reuter, Advanced Materials, 3 (1991) No 11, p. 568; “New inorganic-organic hybrid materials through the sol-gel approach”, Wilkes et al. “Electrical and electrochemical applications of Ormocers“, M. Popall and H. Schmidt, “Hybrid inorganic-organic materials by sol-gel processing of organo-functional metal alkoxides”, Schubert et al., Chem. Mater. (1995), 7, p. 2010-2027. Inorganic-organic composite materials are known to be used in a variety of industrial applications, but, it is to our knowledge the first time that their use in precoat barrier layers in storage phosphor or scintillator panels is disclosed.

It is further not excluded to make use of a combination of polymers in order to improve adhesion characteristics as envisaged.

Chemical vapor deposition (CVD) processes may be applied which are widely known from the deposition of thin films used in semiconductor devices and integrated circuits, and which involve homogeneous or heterogeneous deposition on a substrate as a result of a reaction of chemical vapors. The reaction rate is therein controlled, e.g., by temperature, pressure and reactant gas flow rates. The use of low vapor pressure liquids as precursors for such processes has several advantages and has become more common. A need therefore for a reliable and low maintenance liquid vaporizer which can vaporize liquid at high flow rates and additionally allows independent control of liquid and carrier gas flow rates may be applied as has been disclosed in U.S. Pat. No. 6,224,681. That invention features a vaporizer which accepts a carrier gas and a pressurized liquid. An internal cavity receives the carrier gas through a carrier aperture and combines the carrier gas with vapor formed from liquid received through a liquid aperture. An advantage thereof is that the vaporizer forms vapor by expansion in a pressure gradient, rather than evaporation by heating, and therefore liquid can vaporize at high flow rates such as those needed for some semiconductor fabrication processes, but which is also suitable for application in the method of the present invention. In a preferred embodiment the closure element is a diaphragm movable relative to the liquid aperture in order to increase or decrease the flow rate of the liquid so that the liquid flow rate is advantageously controlled solely by the movement of the diaphragm and that the liquid flow rate is independent of the carrier gas flow rate and therefore can be more accurately controlled. In a further preferred embodiment a heater heats at least a portion of the valve body near to the cavity in order to inhibit the liquid, which has cooled due to expansion, from condensing on the walls of the cavity after it has vaporized.

In a further particular embodiment of the present invention, said precoat layer further contains one or more chromium compound(s).

According to the present invention, in a particular embodiment thereof, a sublayer comprising an inorganic compound is present between said anodized aluminum support and said organic precoat layer. In such a layer arrangement in the phosphor or scintillator panel according to the present invention, said inorganic compound in said sublayer is a metal compound or an oxide compound thereof, wherein said metal is selected from the group consisting of tin, copper, nickel, chromium, scandium, yttrium, tantalum, vanadium, titanium, niobium, cobalt, zirconium, molybdene and tungsten.

According to the present invention, in another particular embodiment thereof, a sublayer comprising an organic compound is present between said anodized aluminum support and said organic precoat layer. More particularly said organic compound is a polymer selected from the group consisting of cellyte, poly-acrylate, poly-methyl-methacrylate, poly-methylacrylate, polystyrene, polystyrene-acrylonitrile, polyurethane, hexafunctional polyacrylate, poly-vinylidene-difluoride and epoxy functionalized polymers. In another particular embodiment said organic compound is a poly-p-xylylene polymer. “Parylene C” is advantageously used therefor in favor of adhesion characteristics. General literature with respect to “parylene” polymer films can be found in e.g. Martin H. Kaufman, Herman F. Mark, and Robert B. Mesrobian, “Preparation, Properties and Structure of Polyhydro-carbons derived from p-Xylene and Related Compounds,” vol. XIII, 1954, pp. 3-20 and Andreas Griener, “Poly(1,4-xylylene)s: Polymer Films by Chemical Vapor Deposition,” 1997, vol. 5, No. 1, January, 1997, pp. 12-16. “Parylene”, a generic name for thermoplastic polymers and copolymers based on p-xylylene and substituted p-xylylene monomers, has been shown to possess suitable physical, chemical, electrical, and thermal properties for use in integrated circuits. Deposition of such polymers by vaporization and decomposition of a stable dimer, followed by deposition and polymerization of the resulting reactive monomer, has been discussed by Ashok K. Sharma in “Parylene-C at Subambient Temperatures”, published in the Journal of Polymer Science: Part A: Polymer Chemistry, Vol. 26, at pages 2953-2971 (1988). “Parylene” polymers are typically identified as Parylene-N, Parylene-C, and Parylene-F corresponding to non-substituted p-xylylene, chlorinated p-xylylene, and fluorinated p-xylylene, respectively. Properties of such polymeric materials, including their low dielectric constants, are further discussed by R. Olson in “Xylylene Polymers”, published in the Encyclopedia of Polymer Science and Engineering, Volume 17, Second Edition, at pages 990-1024 (1989). Parylene-N is deposited from non-substituted p-xylyene at temperatures below about 70-90° C. The substituted dimers are typically cracked at temperatures which degrade the substituted p-xylylene monomers, and the parylene-C and parylene-F films must be deposited at temperatures substantially lower than 30° C. In a preferred embodiment according to the present invention, the protective coating is adhered to the phosphor screen or panel by chemical vapor deposition (CVD) and the vapor deposited film is a vacuum deposited polymeric film and more particularly a poly-p-xylylene film. A poly-p-xylylene has repeating units in the range from 10 to 10000, wherein each repeating unit has an aromatic nuclear group, whether or not substituted. Each substituent group, if present, can be the same or different and can be any inert organic or inorganic group which can normally be substituted on aromatic nuclei. Illustrations of such substituent groups are alkyl, aryl, alkenyl, amino, cyano, carboxyl, alkoxy, hydroxylalkyl, carbalkoxy and like radicals as well as inorganic radicals such as hydroxyl, nitro, halogen and other similar groups which are normally substitutable on aromatic nuclei. Particularly preferred of the substituted groups are those simple hydrocarbon groups such as the lower alkyl such as methyl, ethyl, propyl, butyl, hexyl and halogen groups particularly chlorine, bromine, iodine and fluorine as well as the cyano group and hydrogen. According to the method of the present invention these polymers are formed on phosphor screens or panels by the pyrolysis and vapor deposition of a di-p-xylylene. These materials are the subject of several US-A's such as U.S. Pat. No. 3,117,168 entitled “Alkylated Di-p-Xylylenes”, U.S. Pat. No. 3,155,712 entitled “Cyanated Di-p-Xylylenes” and U.S. Pat. No. 3,300,332 entitled “Coated Particulate Material and Method for Producing Same”. Pyrolysis of the vaporous di-p-xylylene occurs upon heating the dimer from about 450° C. to about 700° C. and preferably about 550° C. to about 700° C. Regardless of the pressure employed pyrolysis of the starting di-p-xylylene begins at about 450° C. At temperatures above 700° C. cleavage of the constituent groups can occur resulting in a tri- or polyfunctional species causing cross-linking of highly branched polymers. It is preferred that reduced or subatmosphere pressures are employed for pyrolysis to avoid localized hot spots. For most operations pressures within the range of 0.0001 to 10 mm of Hg are practical. However desired greater pressures can be employed. Likewise inert inorganic vapor diluents such as nitrogen, argon, carbon dioxide and the like can be employed to vary the optimum temperature of operation or to change the total effective pressure of the system. The diradicals formed in the manner described above are made to impinge upon the surface of the particulate material having surface temperatures below 200° C. and below the condensation temperature of the diradicals present thereby condensing thereon and spontaneously polymerising. As a basic agent the commercially available di-p-xylylene composition sold by the Union Carbide Co. under the trademark “Parylene” is thus preferred. The preferred compositions for the protective moisture-proof protective layer covering the phosphor screens or panels thus are the unsubstituted “Parylene N”, the monochlorine substituted “Parylene C”, the dichlorine substituted “Parylene D” and the “Parylene HT” (a completely fluorine substituted version of Parylene N, opposite to the other “parylenes” resistant to heat up to a temperature of 400° C. and also resistant to ultra-violet radiation, moisture resistance being about the same as the moisture resistance of “Parylene C”: see the note about “High Performance Coating for Electronics Resist Hydrocarbons and High Temperature” written by Guy Hall, Specialty Coating Systems, Indianapolis, available via www.scscookson.com. Technology Letters have also been made available by Specialty Coating Systems, a Cookson Company, as e.g. the one about “Solvent Resistance of the Parylenes”, wherein the effect of a wide variety of organic solvents on Parylenes N, C, and D was investigated. In a preferred embodiment according to the method of the present invention said parylene layer is a halogen-containing layer. More preferably said para-xylylene or “parylene” in the precoat layer of the phosphor or scintillator panel of the present invention is selected from the group consisting of Parylene D®, Parylene C® and Parylene HT®. In the present invention use is most favorably made from “Parylene C”® as the “Parylene C”® is exceptionally, besides offering good adhesion, in favor of preventing corrosion of the aluminum support.

In the preparation method of the screen or panel according the present invention said precoat layer is coated by a technique selected from the group consisting of roller coating, knife coating, doctor blade coating, spray coating, sputtering, physical vapor deposition and chemical vapor deposition. Combined techniques may also be applied, as e.g. vapor deposition of a parylene layer, followed by coating thereupon another organic polymer, inorganic polymer or a composite inorganic-organic compound layer.

According to the method of preparing a radiation image phosphor or scintillator panel according to the present invention said phosphor or scintillator layer is coated by a technique selected from the group consisting of physical vapor deposition, chemical vapor deposition and an atomization technique.

Furtheron in the phosphor or scintillator panel according to the present invention, said stimulable phosphor or scintillator layer comprises needle-shaped phosphor or scintillator crystals having an alkali metal halide as a matrix compound and a lanthanide as an activator compound.

In a particular embodiment according to the present invention, the said needle-shaped phosphor is a photostimulable CsBr:Eu phosphor.

A photostimulable CsBr:Eu phosphor in form of needles, selected from a viewpoint of high sensitivity and high sharpness, is advantageously provided with amounts of Eu as an activator or dopant, in the range from 0.0001 to 0.01 mole/mole of CsBr, and more preferably from 0.0003 to 0.005 mole/mole. In the case of a stimulable CsBr:Eu phosphor, the europium compound of the evaporation source preferably may start from a divalent europium Eu²⁺ compound and a trivalent Eu³⁺ compound: said europium compound may be EuBrₓ in which x satisfies the condition of 2.0≦x≦2.3, wherein a europium compound containing the divalent europium compound as much as possible, i.e. at least 70%, is desired.

Although the thickness of the phosphor layer changes with the sensitivity class of the photostimulable phosphor, it is desirable to deposit a phosphor layer having a thickness from 100 μm to 1000 μm, more preferable from 200 μm to 800 μm, and still more preferable from 300 μm to 700 μm. Too thin a phosphor layer causes too little absorbed amounts of radiation, an increased transparency, and a deteriorated image quality of the obtained radiation image, whereas too thick a phosphor layer will cause image quality to decrease, due to a lowered sharpness.

In a method of preparing a radiation image storage panel according to the present invention, said phosphor layer is coated onto the sublayer by a technique selected from the group consisting of physical vapor deposition, chemical vapor deposition and an atomization technique. As an atomization technique, electron beam vaporization can be used, as has e.g. been described in U.S. Pat. Nos. 6,740,897 and 6,875,990 and in US-Applications 2002/050570, 2004/075062 and 2004/149931, which are incorporated herein by reference. In the electron beam evaporation technique, an electron beam generated by an electron gun is applied onto the evaporation source and an accelerating voltage of electron beam preferably is in the range of 1.5 kV to 5.0 kV. By applying the electron beam technique, the evaporation source of matrix component and activator element is heated, vaporized, and deposited on the substrate. Physical vapor deposition techniques as suitable for use in the deposition of binderless needle-shaped crystals in the phosphor layer of the present invention, such as resistive heating, sputtering and RF induction techniques. Resistive heating vacuum deposition, may advantageously be applied as has been described e.g. in U.S. Pat. Nos. 6,720,026; 6,730,243 and 6,802,991 and in US-Application 2001/007352, which are incorporated herein by reference. This technique is recommended as a method in order to vapor deposit the needle-shaped binderless storage phosphors for a panel according to the present invention. In the resistance heating evaporation, the evaporation sources are heated by supplying electrical energy to the resistance heating means: crucible or boat configurations—preferably composed of refractory materials—in a vapor deposition apparatus, in order to practically realize a homogeneous deposit of vapor deposited phosphor material may be applied as has e.g. been disclosed in US-Applications 2005/000411, 2005/000447 and 2005/217567, which are incorporated herein by reference.

Vapor deposition in a vacuum deposition apparatus requires adjustment of a predetermined degree of vacuum. For a binderless needle-shaped storage phosphor layer in a panel according to the present invention, formation of said phosphor under a high vacuum is desirable: the degree of vacuum of 1×10⁻⁵ to 5 Pa, and, more specifically, from 1×10⁻² to 2 Pa is desired, wherein an inert gas, such as an Ar or Ne noble gas, or alternatively, an inert gas as nitrogen gas, may be introduced into the vacuum deposition s apparatus. Evacuation to give an even lower inner pressure of 1×10⁻⁵ to 1×10⁻² Pa is more preferred for electron beam evaporation. Introduction of oxygen or hydrogen gas may be advantageously performed, more particularly in order to enhance reactivity and/or e.g. in an annealing step. Introduction of an inert gas can moreover be performed in favor of cooling the vapor stream before deposition onto the substrate and/or the substrate, whereupon phosphor vapor raw materials should be deposited as disclosed in U.S. Pat. No. 6,720,026. Alternatively one side of the support may be heated while the other side may be cooled while performing vapor deposition as disclosed in U.S. Pat. No. 7,029,836, which is incorporated herein by reference. The deposition rate generally is in the range of 0.1 to 1,000 μm/min., preferably in the range of 1 to 100 μm/min. It is not excluded to perform a pretreatment to the support, coated with the sublayer as in the present invention: in favor of an enforced drying step, the layer arrangement before phosphor deposition is held at a high temperature during a defined time. It is even not excluded to increase the percentage of relative humidity until the surface of the sublayer starts hydrating, in order to get a smooth base for the phosphor layer. Efficient deposition of the storage phosphor layer onto the substrate however, requires temperatures for the substrate in the range from 50° C. to 250° C. as has been disclosed in US-Application 2004/081750, which is incorporated herein by reference. Heating or cooling the substrate during the deposition process may thus be steered and controlled as required.

Phosphor raw materials comprising matrix and activator compounds are advantageously present as precursors in form of powders or tablets. Examples of phosphor precursor materials useful in the context of the present invention have been described in US-Applications 2005/184250, 2005/184271 and 2005/186,329, which are incorporated herein by reference. Evaporation may be performed from one or more crucibles. In the presence of more than one crucible, an independent vaporization control may be performed in favor of uniformity, homogeneity and/or dedicated incorporation of activator or dopant. This is more particularly preferred when differences in vapor pressure between matrix and activator compound are significant, as is the case e.g. for CsBr and EuOBr or EuBrₓ in which x satisfies the condition of 2.0≦x≦2.3.

Average amounts of Europium dopant incorporated in the needle-shaped CsBr:Eu crystals are in the range from 150 to 750 μmol/mol, and more preferably in the range from 200 to 600 μmol/mol.

The formed phosphor layer comprises prismatic, needle-shaped stimulable phosphor crystals which are aligned almost perpendicularly to the substrate. The thus formed phosphor layer only comprises the stimulable phosphor, without presence of a binder, and there are produced cracks extending the depth direction in the phosphor layer. In favor of image quality, especially sharpness, the needle-shaped phosphor layer may advantageously be colored with a colorant which does not absorb the stimulated emission but the stimulating rays as has e.g. been described in U.S. Pat. No. 6,977,385, which is incorporated herein by reference.

After the deposition procedure is complete, the deposited layer is preferably subjected to heat treatment, also called “annealing”, which is carried out generally at a temperature of 100 to 300° C. for 0.5 to 3 hours, preferably at a temperature of 150 to 250° C. for 0.5 to 2 hours, under inert gas atmosphere which may contain a small amount of oxygen gas or hydrogen gas. Annealing procedures may be applied as described in U.S. Pat. Nos. 6,730,243; 6,815,692 and 6,852,357 or in US-Applications 2004/0131767, 2004/0188634, 2005/0040340 and 2005/0077477, which are incorporated herein by reference.

The layer arrangement of the screens or panels, consisting of a dedicated support whereupon a phosphor or scintillator layer is deposited as disclosed in the present invention, is further advantageously protected with a protective layer at the side of the phosphor or scintillator layer. A transparent protective film on the surface of the stimulable phosphor layer is advantageously applied in order to ensure good handling of the radiation image storage panel in transportation steps and in order to avoid deterioration and damaging. Chemically stable, physically strong, and of high moisture proof coatings are advantageously provided by overcoating the phosphor or scintillator layer with a solution in which an organic polymer (e.g., cellulose derivatives, polymethyl methacrylate, fluororesins soluble in organic solvents) is dissolved in a solvent, by placing a sheet prepared beforehand for the protective film (e.g., a film of organic polymer such as polyethylene terephthalate, a transparent glass plate) on the phosphor film with an adhesive, or by depositing vapor of inorganic compounds on the phosphor film. Protective layers may thus be composed of materials such as a cellulose acetate, nitrocellulose, polymethyl-methacrylate, polyvinyl-butyral, polyvinyl-formal, polycarbonate, polyester, polyethylene terephthalate, polyethylene, polyvinylidene chloride, nylon, polytetrafluoroethylene and tetrafluoroethylene-6 fluoride propylene copolymer, a vinylidene-chloride-vinyl chloride copolymer, and a vinylidene-chloride-acrylonitrile copolymer. A transparent glass support may also be used as a protective layer. Moreover, by vacuum deposition, making use e.g. of the sputtering technique, a protective layer of SiC, SiO2, SiN, and Al₂O₃ grade may be formed. Various additives may be dispersed in the protective film. Examples of the additives include light-scattering fine particles (e.g., particles of magnesium oxide, zinc oxide, titanium dioxide and alumina), a slipping agent (e.g., powders of perfluoroolefin resin and silicone resin) and a cross-linking agent (e.g. polyisocyanate). Preferred thicknesses of protective layers are in the range from 1 μm up to 20 μm for polymer coatings and even up to 2000 μm in case of inorganic materials as e.g. silicate glass. For enhancing the resistance to stain, a fluororesin layer is preferably provided on the protective film. Fluororesin layers may be formed by coating the surface of the protective film with a solution in which a fluororesin is dissolved or dispersed in an organic solvent, and drying the coated solution. The fluororesin may be used singly, but a mixture of the fluororesin and a film-forming resin may be employed. In the mixture, an oligomer having polysiloxane structure or perfluoroalkyl group may be added furtheron. In the fluororesin layer, a fine particle filler may be incorporated to reduce blotches caused by interference and to improve the quality of the resultant image. The thickness of the fluororesin layer is generally in the range of 0.5 to 20 μm. For forming such a fluororesin layer, additives such as a cross-linking agent, a film-hardening agent and an anti-yellowing agent may be used. In particular, the crosslinking agent is advantageously employed to improve durability of the fluororesin layer. In order to further improve the sharpness of the resultant image in a storage phosphor panel with a photostimulable phosphor, at least one layer may be colored with a colorant which does not absorb the stimulated emission, normally emitted in the wavelength range from 300 to 500 nm, but effectively absorbs the stimulating radiation in the wavelength range from 400 to 900 nm.

In another embodiment heating the phosphor plate in an organic solvent gas and sealing the phosphor plate with a moisture-proof protective film in order to prepare the radiation image storage panel as in published US-Application 2006/0049370, may be applied.

Further embodiments of protective layers suitable to be applied can be found in U.S. Pat. Nos. 6,710,356; 6,800,362; 6,822,243; 6,844,056; 6,864,491 and 6,984,829 and in US-Applications 2004/0164251, 2005/0067584, 2004/0183029, 2004/0228963, 2005/0104009, 2005/0121621, 2005/0139783, 2005/0211917, 2005/0218340, 2006/0027752 and 2006/0060792, which are incorporated herein by reference, without however being limitative.

### EXAMPLES

While the present invention will hereinafter be described in connection with preferred embodiments thereof, it will be understood that it is not intended to limit the invention to those embodiments.

### Example 1

An aluminum layer support having magnesium in an amount of 3 wt % in all of the plates (i.e. CB73805-CB73863 and CB73823), except for plate CB73872 (no Mg in aluminum support). CB73805 stands for a comparative panel without any precoat layer.

Anodization treatment was performed in order to get an anodized layer: besides said treatment, a thickness thereof, expressed in μm, has been given in the Table 1.

Presence of “Parylene C”® as precoat layer (inventive plates CB73863 and CB73823) or organic silane coating (inventive plate CB73872), or absence of a precoat layer as in comparative plate CB73805 onto the anodized aluminum support has been indicated by its thickness (in μm) as set out in Table 1.

CsBr:Eu photostimulable phosphor screens were prepared on anodized aluminum plates, prepared as indicated hereinbefore, in a vacuum chamber by means of a thermal vapor deposition process, starting from a mixture of CsBr and EuOBr as raw materials. Said deposition process onto said anodized aluminum supports was performed in such a way that said support was rotating over the vapor stream.

An electrically heated oven and a refractory tray or boat were used, in which 160-200 g of a mixture of CsBr and EuOBr as raw materials in a 99.5%/0.5% CsBr/EuOBr percentage ratio by weight were present as raw materials to become vaporized.

As a crucible an elongated boat having a length of 100 mm was used, having a width of 35 mm and a side wall height of 45 mm composed of “tantalum” having a thickness of 0.5 mm, composed of 3 integrated parts: a crucible container, a “second” plate with slits and small openings and a cover with slit outlet. The longitudinal parts were fold from one continuous tantalum base plate in order to overcome leakage and the head parts are welded. Said second plate was mounted internally in the crucible at a distance from the outermost cover plate which was less than ⅔ of said side wall height of 45 mm. Under vacuum pressure (a pressure of 2×10⁻¹ Pa equivalent with 2×10⁻³ mbar) maintained by a continuous inlet of argon gas into the vacuum chamber, and at a sufficiently high temperature of the vapor source (760° C.) the obtained vapor was directed towards the moving sheet support and was deposited thereupon successively while said support was rotating over the vapor stream. Said temperature of the vapor source was measured by means of thermocouples present outside and pressed under the bottom of said crucible and by tantalum protected thermocouples present in the crucible.

The anodized aluminum support having a thickness of 800 μm, a width of 10 cm and a length of 10 cm, was positioned at the side whereupon the phosphor should be deposited at a distance of 22 cm between substrate and crucible vapor outlet slit.

Plates were taken out of the vapor deposition apparatus after having run same vapor deposition times, leading to phosphor plates having phosphor layers of about equal thicknesses.

A protective sheet was further coated and the adhesive strength of the phosphor layer onto the anodized aluminum support was further tested. In each case it was clear that the adhesiveness of the protective coating onto the phosphor layer was at least as strong as the adhesiveness of the phosphor layer onto the anodized aluminum support for each phosphor screen.

Data about coating weight of the phosphor, relative speed (fresh and after conditioning) have been set out in the Table 2, wherein relative speed (SAL %) is defined as the speed of each of the screens compared with the reference speed of an MD10® reference photostimulable phosphor screen manufactured by Agfa-Gevaert, Mortsel, Belgium.

Adhesion of the layers was evaluated during handling of the rigid aluminum plates, i.e. during at least one of following steps: (1) removing the vapor deposited phosphor plate from vacuum chamber in the vapor depositing apparatus; (2) application of identification means to the plate (e.g. by inscription); (3) testing of the plate (e.g. testing its behavior in a conditioning room at well-defined temperature and humidity conditions.

TABLE 1

| | | | | Organic | | Organic | |
|---|---|---|---|---|---|---|---|
| | | Thickness | | precoat | | precoat | |
| Plate | Anodization | anodized | | layer | | layer | Adhesion |
| No. | & sealing | layer | Mg wt % | thickness | | compound | control (*) |
| CB73805 | H₂SO₄ anod.; | >20 μm | 3 | 0 | | — | 3 |
| | H₂O sealing | | | | | | |
| CB73863 | H₂SO₄ anod.; | >20 μm | 3 | 4 | μm | Par.C | 2 |
| | H₂O sealing | | | | | | |
| CB73872 | H₂SO₄ anod.; | 1 μm | 0 | <5 | μm | Org.Sil. | 1 |
| | H₂O sealing | | | | | | |
| CB73823 | H₂SO₄ anod.; | >20 μm | 3 | 4 | μm | Par.C | 1–2 |
| | H₂O sealing | | | | | | |

(*) Adhesion: 1 = excellent; 2 = good; 3 = acceptable; 4 = bad

FIG. “4” was indicative for a “bad” adhesion, whereas “3” was related with “critical” adhesion of the reference plate (not completely satisfying—causing adhesion problems more than once);

FIG. “2” was indicative for a “better” adhesion (acceptable, occasionally—rarely—showing an adhesion problem) and

FIG. “1” was indicative for “good” adhesion (no delamination ever observed between support and phosphor layer while tearing the tape off).

From adhesion tests as described above, it was clear that all of the inventive plates were showing a good to excellent adhesion, whereas for the comparative plate CB73805 adhesiveness was just acceptable.

Even with a very thin anodized layer as for CB73872, a good adhesion could be attained in the presence of a thin organo silane-based precoat, having a thickness of less than 5 μm.

TABLE 2

| | Phosphor | | Speed after |
|---|---|---|---|
| | coating wt. | Speed or | 7 days |
| Plate No. | (mg/cm²) | sensitivity | 20° C./80% RH |
| CB73805 | 42.0 | 52 | 22 |
| CB73863 | 45.0 | 96 | 27 |
| CB73872 | 45.6 | 154 | 63 |
| CB73823 | 43.9 | 86 | 13 |

Table 2 is illustrative for the excellent speed, acceptable speed decrease in severe conditions of high relative humidity during a time of one week, and sharpness at 1 line pair per mm, more particularly for inventive storage phosphor plate CB73872 having a thin organotetrasilane coating.

### Example 2

Anodization treatment was performed in order to get an anodized layer having a thickness of 5 μm.

Coating weight of phosphor was set at about 50 mg/cm² (48.0; 51.7 and 49.8 resp. for the CB-plates 72721, 72724 and 72723 respectively).

TABLE 3

| | Anodization; | Substrate | Precoat | | Corrosion | | SAL |
|---|---|---|---|---|---|---|---|
| Plate No. | sealing | name | thickn. | | evaluation | Mg | % |
| CB72721 | H₂SO₄ anod.; | P51 | 0 | | 4 | 0 | 143 |
| | H₂O sealing | | | | | | |
| CB72724 | H₂SO₄ anod.; | P51 | 4 | μm | 2 | 0 | 139 |
| | H₂O sealing | | | | | | |
| CB72723 | H₂SO₄ anod.; | N61 | 0 | | 4 | 0 | 144 |
| | H₂O sealing | | | | | | |

Corrosion evaluation: 1 = excellent; 2 = good; 3 = acceptable; 4 = bad

Presence of a PARYLENE C® layer as a substrate or intermediate layer between the anodized Al support thus provides an adequate corrosion protection as can be observed from absence of disturbing pittings on the “flat field”: the term “flat field” should be understood herein as “uniformly exposed”, i.e. exposed with a constant intensity and with a homogeneous energy distribution in order to avoid “phantoms”.

In a standard procedure use is made therefor from RQA 5 (International Electrotechnical Commission—IEC61267:1994) beam quality.

Moreover a good adhesion between support and phosphor layer is observed as envisaged, wherein said adhesion is controlled while “handling” as defined hereinbefore.

Having described in detail preferred embodiments of the current invention, it will now be apparent to those skilled in the art that numerous modifications can be made therein without departing from the scope of the invention as defined in the appending claims.

What is claimed is:

1. A radiation image phosphor or scintillator panel comprising as a layer arrangement of consecutive layers: an anodized aluminium support, a precoat layer and a phosphor or scintillator layer comprising needle-shaped phosphor or scintillator crystals, wherein said precoat layer is consisting of an organic polymer layer having a thickness in the range from 4 μm to 15 μm when said polymer is selected from the group consisting of cellyte, poly-acrylate, poly-methyl-methacrylate, poly-methylacrylate, polystyrene, polystyrene-acrylonitrile, polyurethane, hexafunctional polyacrylate, poly-vinylidene-difluoride and epoxy functionalized polymers; and wherein said precoat layer has a thickness in the range from 1 μm to less than 5 μm when said polymer is an organo-silane based polymer.

2. Panel according to claim 1, wherein said organo-silane based polymer is organo-tetrasilane.

3. Panel according to claim 1, wherein a sublayer comprising an inorganic compound is present between said anodized aluminum support and said organic precoat layer.

4. Panel according to claim 2, wherein a sublayer comprising an inorganic compound is present between said anodized aluminum support and said organic precoat layer.

5. Panel according to claim 3, wherein said inorganic compound is a metal compound or an oxide compound thereof, wherein said metal is selected from the group consisting of tin, copper, nickel, chromium, scandium, yttrium, tantalum, vanadium, titanium, niobium, cobalt, zirconium, molybdene and tungsten.

6. Panel according to claim 4, wherein said inorganic compound is a metal compound or an oxide compound thereof, wherein said metal is selected from the group consisting of tin, copper, nickel, chromium, scandium, yttrium, tantalum, vanadium, titanium, niobium, cobalt, zirconium, molybdene and tungsten.

7. Panel according to claim 1, wherein a sublayer comprising an organic compound is present between said anodized aluminum support and said organic precoat layer.

8. Panel according to claim 2, wherein a sublayer comprising an organic compound is present between said anodized aluminum support and said organic precoat layer.

9. Panel according to claim 7, wherein said organic compound is a polymer is selected from the group consisting of cellyte, poly-acrylate, poly-methyl-methacrylate, poly-methylacrylate, polystyrene, polystyrene-acrylonitrile, polyurethane, hexafunctional polyacrylate, poly-vinylidene-difluoride and epoxy functionalized polymers.

10. Panel according to claim 8, wherein said organic compound is a polymer is selected from the group consisting of cellyte, poly-acrylate, poly-methyl-methacrylate, poly-methylacrylate, polystyrene, polystyrene-acrylonitrile, polyurethane, hexafunctional polyacrylate, poly-vinylidene-difluoride and epoxy functionalized polymers.

11. Panel according to claim 7, wherein said organic compound is poly-p-xylylene.

12. Panel according to claim 8, wherein said organic compound is poly-p-xylylene.

13. Panel according to claim 1, wherein said anodized aluminium support has an anodized layer having a thickness of 5 μm or less.

14. Panel according to claim 3, wherein said anodized aluminium support has an anodized layer having a thickness of 5 μm or less.

15. Panel according to claim 7, wherein said anodized aluminium support has an anodized layer having a thickness of 5 μm or less.

16. Panel according to claim 1, wherein said anodized aluminium support has an anodized layer having a thickness of at most 1 μm.

17. Panel according to claim 3, wherein said anodized aluminium support has an anodized layer having a thickness of at most 1 μm.

18. Panel according to claim 5, wherein said anodized aluminium support has an anodized layer having a thickness of at most 1 μm.

19. Panel according to claim 1, wherein said stimulable phosphor or scintillator layer comprises needle-shaped phosphor or scintillator crystals having an alkali metal halide as a matrix compound and a lanthanide as an activator compound.

20. Panel according to claim 1, wherein said needle-shaped phosphor is a photostimulable CsBr:Eu phosphor.
